(19) United States
(12) Patent Application Publication
(10) Pub. No.: US 2006/0236556 A1
(43) Pub. Date: Oct. 26, 2006

(54) Dishwasher drying system

(75) Inventors: Jerry Wayne Ferguson, Greenwood, MS (US); John Frederick Morrison, Greenwood, MS (US); Jeffrey Alan Ryals, Sidon, MS (US); David Clinton Weaver, Greenwood, MS (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Viking Range Corporation

(21) Appl. No.: 11/113,698

(22) Filed: Apr. 25, 2005

(51) Int. Cl. F26B 21/06; F26B 3/00

(52) U.S. Cl. 34/73; 34/468

(57) ABSTRACT

A dishwasher with a novel drying cycle is provided. The dishwasher door includes a vent channel connecting the interior of the dishwasher to the outside and housing a condenser section that condenses water vapor from moisture laden air from the interior of the dishwasher and directs the condensed water back into the dishwasher. A vent valve covers the opening of the vent channel into the dishwasher and is opened and closed at appropriate times during the drying cycle. A heater adjacent a blower heats air entering the dishwasher. A temperature sensor in the dishwasher interior provides temperature measurements of the inside of the dishwasher that may be used to control the duration of the drying cycle. A controller interconnects the operating components of the dishwasher and provides the logic for the drying cycle.

### FIELD OF THE INVENTION

The present invention relates to a dishwasher that incorporates a novel drying system.

### BACKGROUND OF THE INVENTION

Most domestic dishwashers incorporate a drying cycle as the last phase of an overall dishwashing cycle. One way to operate a drying cycle in a dishwasher is to allow the final rinse temperature in the dishwasher to reach a relatively high temperature to ensure that the dishes are relatively hot and contain a relatively large amount of thermal energy at the end of the final rinse. Drying is accomplished by a combination of water dripping from the dishes and water vaporizing directly from the dishes' surface. The rate at which the water drips from the dishes slows quickly and vaporization becomes the dominant mechanism of drying. In the early part of the drying phase, the thermal energy contained by the dishes from the final rinse of water supplies most of the energy to drive the water vaporization process. Once the air inside the dishwasher becomes saturated with water vapor, vaporization of water from the surface of the dishes generally stops. In order for vaporization to continue at a relatively high rate, the temperature of the air inside the dishwasher must increase or the humidity of the air must decrease. In most conventional cases, the dishwasher will exhaust the moisture-laden air out of the dishwasher and draw fresh, relatively dry air from the outside into the dishwasher.

The air inlet and exhaust vents are located in several different locations in prior art dishwashers. Generally, the exhaust vent is located high in the dishwasher cavity, in the front of the dishwasher, and usually is incorporated into the door. The inlet vent usually is located near the base of the dishwasher cavity. A high, frontal location of the exhaust vent allows the hot humid air to rise and exit into the room and aids the natural airflow, with the hotter air rising and the cooler, dry air entering at the base of the dishwasher. Additionally, once the hot humid air is exhausted into the typically, relatively cool air surrounding the dishwasher, the moisture-laden air begins to rapidly condense into water. If the water condenses under the cabinet in which the dishwasher is installed, the cabinet and the floor could eventually become water damaged.

The duration of the drying cycle usually is set at a fixed value, which is chosen to allow a large load of dishes to become reasonably dry. This fixed value is used even in poor drying conditions, such as relatively humid outside air surrounding the dishwasher. Generally, four variations of drying cycles are used in domestic dishwashers: heated drying, non-heated drying, forced convection drying, and natural convection drying. The heated or non-heated cycle variation can be used in combination with either the forced or natural convective systems. A heated drying cycle normally uses a dishwasher's water heating element during all or part of the drying cycle to heat the dry, relatively cool air that is drawn into the dishwasher. Although a heated drying cycle helps to keep the dishes warm and shortens the time required for drying, the heated drying cycle has drawbacks, such as being inefficient at transferring heat to the air for the dishes since the water heating element usually is located low in the bottom of the dishwasher. A non-heated drying cycle typically is offered in domestic dishwashers as an energy saving option or as an option for a user for which drying time is unimportant. In general, a non-heated drying cycle does not utilize a heater during the drying phase. A forced convection drying cycle uses a convection fan to forcibly move fresh, dry air through the dishwasher during the drying cycle. The use of a convection fan increases the rate of vaporization of water from the dishes during the drying cycle and uses a relatively small amount of additional energy. Since natural convection forces are overpowered by forced convection, placement of the air inlets and outlets in a forced convection drying cycle is somewhat less critical. Finally, although a natural convection drying cycle does not use a fan or any power method to force convection, the heating element option can still be used to aid heating of the air in a natural convective dry cycle. If the inlet and outlet vents are properly placed, natural convective forces create airflow through the dishwasher to improve drying. Although a natural convection drying cycle consumes less energy and creates less noise than a forced convection drying cycle, it is also much slower than a forced convection drying cycle.

### SUMMARY OF THE INVENTION

The present invention improves conventional drying cycle techniques by utilizing a forced convection design, a moisture laden air condensation element, and a control system to terminate drying as soon as the dishes are determined to have reached their dry state. The present drying system uses a relatively small forced convection blower to force air from the enclosure underneath the machine into the lower portion of the dishwasher tub or washing chamber. Since the inlet is disposed in the lower rear of the dishwasher, the present drying cycle uses the heat transferred from the bottom of the tub of the dishwasher and generated by the pump motor during the wash cycle. Additionally, an electric air heating element is located adjacent the blower to heat the inlet air before it is forced into the dishwasher tub and mixed with the turbulent air in the tub. The turbulent airflow also promotes an even temperature distribution over the dish load throughout the dishwasher. If the air heater were positioned out of the air stream, the heating of the dishes would be less uniform. Although the uniform temperature distribution is important for uniform drying, the uniformity also allows a temperature reading to be taken at one location inside the dishwasher to accurately represent the temperature throughout the dishwasher interior. This temperature information can then be used to detect when the majority of the water has been vaporized from the surface of the dishes.

The exhaust vent assembly is located in the door of the present dishwasher. In order to reduce the temperature and moisture content of the air being expelled into the area around the dishwasher, the exhaust vent is shaped it to act as a condenser. The condenser portion of the exhaust vent assembly has convolutions or corrugations, which increase the surface area available for condensation for the water vapor inside the condenser. The condenser section is separate from, and thermally insulated from, the interior of the dishwasher to prevent the inside of the dishwasher from heating the surfaces of the condenser. Minimal insulation is included between the condenser and the outside of the dishwasher to allow the condenser surface that transfers heat to the area around the dishwasher to remain relatively cool and to increase the efficiency of the condenser. The water that condenses in the vent is directed back to the sump of the dishwasher and the exhaust air is vented into the room or area around the dishwasher from the bottom of the door. This exhaust air enters the room at a relatively low velocity because the area of the vent is relatively large. In addition, the moisture content and temperature of the air being exhausted into the room is reduced, which alleviates the conventional problems caused by heat and the formation of water droplets.

A temperature sensor is placed inside the dishwasher to monitor the overall temperature inside the dishwasher during the drying phase. As the drying cycle progresses, the heat contained by the dishes from the final rinse quickly dissipates. The temperature of the dishes decreases slowly during the course of the drying cycle and eventually the system approaches a steady state between heat being added to the system by the air heater and heat being lost through heated vaporization. When all of the water has vaporized from the surface of the dishes, the rate of decrease of the temperature of the air being exhausted will slow. This change in rate of decrease can be detected and the dishwasher's controller can end the dry cycle at the optimum time to save energy. The controller will shut off the heater and the blower. The controller will also close a vent valve that connects the exhaust vent to the interior of the dishwasher.

### BRIEF DESCRIPTION OF THE DRAWINGS

FIG. 1 is a schematic side view of a cutaway portion of a dishwasher illustrating the present invention.

FIG. 2 is a front view of the dishwasher of FIG. 1 taken generally along the line 2-2.

FIG. 3 is a schematic view of the control system of the present invention showing the interconnection of the components with the dishwasher controller.

### DETAILED DESCRIPTION OF A PREFERRED EMBODIMENT

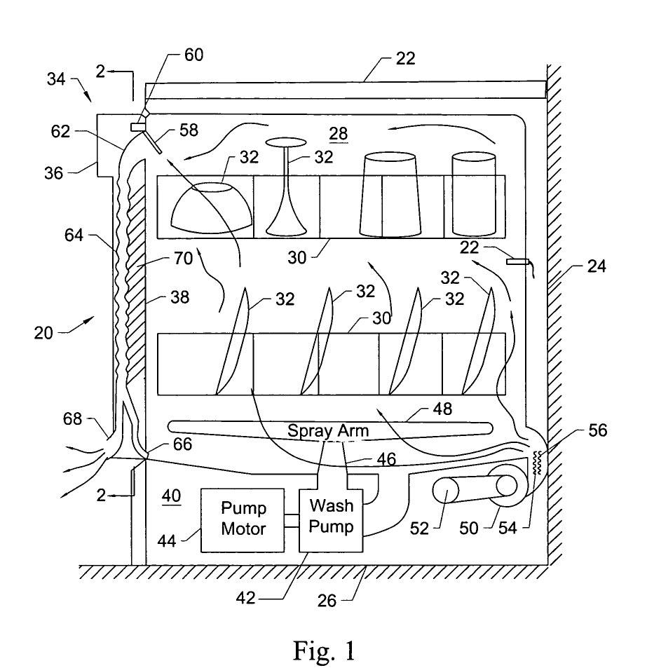

FIG. 1 illustrates a dishwasher 20 installed under a counter 22 against a back wall 24 on a floor 26. The dishwasher 20 includes tub portion 28 defining an interior cavity holding racks 30, which carry articles 32 to be washed. The dishwasher 20 includes a door 34 of double wall construction having a front wall 36 facing the exterior and an interior wall 38 facing into the tub 28 of the dishwasher 20. Typically, the controls for the dishwasher 20 are incorporated into the door 34. For the sake of simplicity in this illustration, the controls have been omitted from FIG. 1. Positioned below the tub 28 is a lower cavity 40 that contains several operational components of the dishwasher, such as a wash pump 42 and a wash pump motor 44. The wash pump 42 and wash pump motor 44 are isolated from the tub 28 and are not exposed to wash water therein. The wash pump 42 supplies water for washing the articles 32 through a hollow shaft 46, which, in turn, supplies water to a spray arm 48, providing the washing and rinsing cycle.

Lower cavity 40 also houses a drying blower 50 with an air inlet 52 capable of intaking air from the lower cavity 40 and from the ambient surroundings. Air is supplied from the air inlet 52 through the drying blower 50 and is directed into the tub 28 through a channel 54 with a heating element 56 located therewithin. The directional arrows in the tub 28 in FIG. 1 show that the air flow from the blower 50 through the channel 54 is distributed uniformly throughout the tub 28. The heating element 56 allows for the provision of heated air into the tub 28.

A vent valve 58 is incorporated into the interior wall 38 of the door 34 and closes or opens a vent channel 62. The vent valve 58 is controlled by an operator 60 that in turn is controlled by the overall dishwasher control system. The vent valve 58 is closed during the normal washing cycle and is opened only during the drying cycle to allow exhaust of air from the interior of the dishwasher. The vent channel 62 is normally closed at its upper end by the vent valve 58. The vent channel 62 passes between the front wall 36 and interior wall 38 of the door 34, extends downward in the door 34, and has a series of convolutions, ridges, or corrugations 64 formed in its central portion. The corrugations 64 aid in the condensation of water vapor from the air in vent channel 62. Adjacent its lower end, the vent channel 62 splits into two branches. Branch 66 directs liquid from the corrugations 64 back into the interior volume 28, while branch 68 opens into the room and allows air to escape from the vent channel 62. The space between the corrugated portion 64 of the vent channel 62 and the interior wall 38 of the door 34 is preferably filled with insulation 70, while the portion of the vent channel 62 that faces the front wall 36 generally is not insulated.

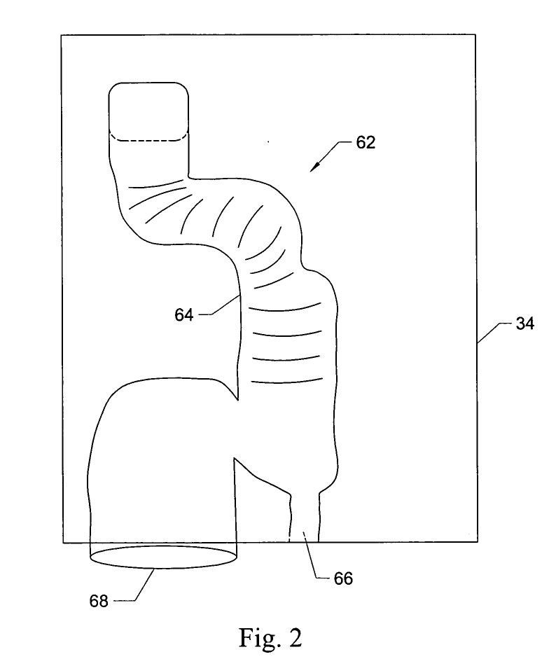

FIG. 2 shows the general configuration of the vent channel 62. As shown, the liquid branch 66 and air branch 68 separates after the corrugated or ridged section 64. The exact shape and number of corrugations in the corrugated section 64 can be adjusted as a function of the expected air temperature and expected air flow. Generally, enough of the corrugated section provides enough surface area to condense a major portion of the water vapor from the exhaust air.

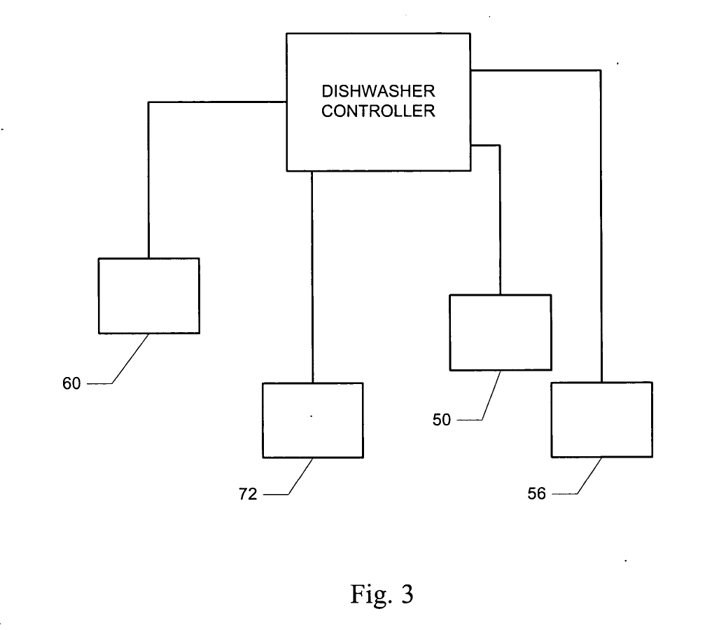

FIG. 3 shows the general control scheme for the dishwasher of the present invention. A master dishwasher controller 74 controls the cycles of the dishwasher, processes electrical signals, and provides electrical signals to turn components on and off. The drying blower 50, the heating element 56 and the operator 60, which controls opening and closing of the vent valve 58, are all controlled by the dishwasher controller 74. A temperature sensor 72, which generally is positioned within the tub 28, provides a signal of the temperature within the dishwasher during the drying cycle to the controller 74. The controller 74, operating in accordance with its pre-set or fixed instructions, turns on or off the blower 50 and heating element 56, depending on the temperature signals received.

In operation, once the final rinse cycle has been completed, the operator 60 receives a signal to open the vent valve 58. At about the same time, the blower 50 will also be activated to bring in outside air from the lower portion of the dishwasher, particularly from the lower cavity 40. The air in the lower cavity 40 generally will be relatively warm because of the components operating within it. The infusion of this warmed air from the lower cavity 40 will aid in the drying of the dishes. The heater element 56 may be turned on at this early point in the cycle or, to take advantage of residual heat in the articles 32, it may be desirable to delay turning on the heating element 56. The air being forced through the tub 28 exits through the vent valve 58 and into the vent channel 62. Once in the vent channel 62, the corrugated section 64 acts as a condenser to cause the moist air that is being exhausted from the interior of the dishwasher to condense. Because little or no insulation is included between the section 64 and the front wall 36, and because thermal insulation 70 is included between section 64 and the hot interior of the dishwasher, the condenser or corrugated section 64 is capable of transferring more efficiently heat from the hot and moist exhaust air and heat from the condensation of water on its inner surfaces to the outside environment. The insulation 70 slows the transfer of heat from the hotter interior of the dishwasher to the condenser through the dishwasher's inner wall. The lack of insulation between the condenser, the cooler surroundings, and the placement of insulation between the relatively hot dishwasher interior and the condenser all contribute to a more rapid net transfer of heat from the condenser to the surroundings. This more rapid transfer of heat results in the condenser's inner surfaces remaining cooler than would be the case without this insulation configuration. The rapid net transfer of heat from the condenser also helps to keep the inner surfaces of the condenser below the dew-point of the moist hot air passing through the condenser. If the walls of the condenser were perfectly insulated from the cooler surroundings, the temperature of the inner walls of the condenser would eventually reach the same temperature as the air passing through the condenser. However, if this occurred, the temperature of the walls of the condenser would rise above the dew-point of the water vapor passing therethrough and condensation would cease. Thus, the efficiency of the condenser is improved by maintaining it as cool as possible, while maximizing the surface area available for condensation to occur. The surface area is effectively increased by the convolutions.

The condensed water flows out the liquid branch 66 and back into the sump portion of the tub 28. The now relatively dry and cool air exits through air branch 68 and into the area around the dishwasher. Accordingly, since the air is relatively cool and dry upon exit, it is less likely to condense in the area around the dishwasher or harm or disturb objects or persons near the dishwasher.

Although the present system generally provides an improved drying cycle in a fixed mode, it is often desirable to optimize the drying cycle and the amount of energy utilized. In such a scenario, the temperature sensor 72 is utilized to signal the dishwasher controller 74. As the drying phase progresses, the heat contained in the dishes from the final rinse dissipates quickly. The temperature of the dishes decreases slowly during the course of the drying cycle and eventually the system approaches a steady state between heat being added to the system by the heating element 56 and heat being lost from heat of vaporization. When all of the water has vaporized from the surface of the dishes, the rate of temperature decrease of the air being exhausted will slow. This rate change in temperature can be detected by the temperature sensor 72, which can signal the controller 74. Then, the controller 74 can terminate the drying cycle by shutting off the heating element 56 and the blower 50. While the invention has been disclosed in its preferred form, it will be apparent to those skilled in the art that many modifications, additions, and deletions can be made without departing from the scope and spirit of the invention or its equivalents as set forth in the following claims.

What is claimed:

1. A dishwasher having a dish drying cycle comprising:
a controller including a pre-set logic for a drying cycle;
a door for allowing access to the interior of said dishwasher and for sealing the interior of said dishwasher during a wash cycle;
a vent channel formed in said door and communicating with the interior of said dishwasher and the outside environment, said vent channel including a condenser section and a liquid outlet branch capable of emptying into the interior of said dishwasher;
a vent valve covering the opening of said vent channel into said dishwasher;
an operator connected to said vent valve and controlled by said controller for opening and closing said vent valve;
a drying blower, connected to said controller, having an outside air inlet and an outlet channel into the interior of said dishwasher; and
a heater, connected to said controller, positioned adjacent said drying blower outlet channel for heating air from said drying blower.

2. The dishwasher of claim 1 further including a temperature sensor, connected to said controller, positioned in the interior of said dishwasher for generating a signal representing the temperature in the interior of said dishwasher.

3. The dishwasher of claim 1 wherein said condenser section is comprised of a series of corrugations formed in said vent channel.

4. The dishwasher of claim 1 further including insulation positioned in said door between said vent channel and the interior of said dishwasher.

5. The dishwasher of claim 1 wherein the outside air inlet for said drying blower is positioned in the lower portion of said dishwasher outside the interior.

6. The dishwasher of claim 1 wherein said heater is positioned in the outlet channel connected to said drying blower.

7. A method for drying contents of a dishwasher comprising:
blowing air through the dishwasher with a powered blower;
heating the air entering the dishwasher;
exhausting the air from the dishwasher through a vent channel in a door of the dishwasher;
condensing water vapor from the exhaust air in the vent channel to dry the exhaust air;
directing condensed water, condensed from the water vapor, into the interior of the dishwasher; and
directing the dried exhaust air outside the dishwasher.

8. The method of claim 7 further comprising:
sensing a temperature inside the dishwasher; and
controlling a duration of the drying as a function of a pre-selected change sensed in the temperature.

9. The method of claim 7 further comprising:
insulating the vent channel from the interior of said dishwasher.

10. The method of claim 7 further comprising:
providing air to said powered blower from an enclosed space below the interior of said dishwasher, said enclosed space housing operating components of said dishwasher.

11. The method of claim 7 wherein the step of condensing water vapor includes the steps of:
passing the exhaust air over a series of corrugations formed in the vent channel to condense additional moisture from the exhaust air.

12. The method of claim 11 further comprising:
insulating the vent channel from the interior of said dishwasher.
